(19) United States
(12) Patent Application Publication
(10) Pub. No.: US 2005/0010634 A1
(43) Pub. Date: Jan. 13, 2005

(54) Methods, systems, and computer program products for portlet aggregation by client applications on a client side of client/server environment

(76) Inventors: Roderick C. Henderson, Apex, NC (US); Yongcheng Li, Raleigh, NC (US); Thomas F. McElroy, Raleigh, NC (US)

Correspondence Address: MYERS BIGEL SIBLEY & SAJOVEC, PO BOX 37428, RALEIGH, NC, 27627, US

(21) Appl. No.: 10/464,910

(22) Filed: Jun. 19, 2003

(51) Int. Cl. G06F 15/16

(52) U.S. Cl. 709/201; 709/217

(57) ABSTRACT

Information can be provided to a client application by aggregating, on a client side of a logically separated client side/server side computing environment, information retained on the client side that is displayed by a client application with requested information provided by a portal application server on the server side of the client side/server side environment for display by the client application. Related systems and computer program products are discussed.

### FIELD OF THE INVENTION

This invention relates to methods, systems, and computer program products for processing information, and more particularly, to methods, systems, and computer program products for processing information in a networked computer environment.

### BACKGROUND

With the increase in the popularity of the “World Wide Web” (WWW), the use of so-called “web browsers” or “browsers” has become more common. For example, a web browser available from Netscape, Inc., known as Netscape Navigator, can provide a convenient way to operate applications and view data via the web.

Some of the applications available via the web can provide a high level of interaction with the user as these applications may be written in native languages (such as C or Java). In particular, applications written in these types of native languages can be specifically written to require intensive user interaction. As the level of interaction between the user and the application increases, so can the communication between the web browser and the application. This increase in communication can cause enough requests and associated responses that the available network bandwidth is affected.

In addition to the problems outlined above regarding generic applications, a new type of environment, commonly referred to as the “emerging web desktop,” may cause even greater problems similar to those discussed above. In particular, the emerging web desktop can provide users with access to what is commonly referred to as a portal. The portal can allow a user to access multiple applications through a single screen (displayed by the web browser). For example, some portals allow users to access applications that can show disparate data, such as weather, sports, stock information, or the like, to a user on a single screen. Much of the processing needed to manage the portal (such as administration, customization, and switching) can place even greater demands on the bandwidth available between the browser and the application.

It is known to use a technology commonly referred to as “Xforms” to address some of the performance issues that arise when using a web browser to access data over the web. In particular, XForms technology can treat the data to be presented in a web browser separately from how the data is to be presented. XFornms technology, however, does not address some of the issues discussed above that can arise when using a web browser to access applications and/or data via the web.

### SUMMARY

Embodiments according to the invention can provide methods, systems, and computer program products for providing information to a client application. Pursuant to method embodiments, information can be provided to a client application by aggregating, on a client side of a logically separated client side/server side computing environment, information retained on the client side that is displayed by a client application with requested information provided by a portal application server on the server side of the client side/server side environment for display by the client application.

Accordingly, the aggregation of the information to be displayed can be provided on the client side rather than on the server side, thereby reducing the load on the portal application server and reducing the required bandwidth allocated to the web browser. In some embodiments according to the present invention, the web browser can be used to access a portal which supports multiple portlets, each of which can be customized by a user to display desired information. In some embodiments according to the invention, the web browser only requests the information that is needed for an updated display of the portal associated with the requested information and can avoid requesting information that is not needed for the updated display. By avoiding requesting information that is not needed, the load on the portal application server can be further reduced.

In some embodiments according to the invention, the step of aggregating can include combining information retained on the client side for display by the client application with the requested information to provide a computer displayable document for display by the client application. In some embodiments according to the invention, the step of aggregating includes requesting the information from the portal application server on the server side by the client application on the client side. The requested information can be provided from the portal application server to the client application responsive to the requesting information by the client application. The requested information can be aggregated with information retained on the client side for display by the client application. In some embodiments according to the invention, a request for information retained on the client side can be avoided.

In some embodiments according to the invention, the step of requesting can further include determining that the information is needed for display by the client application of an updated computer displayable document. The information can be requested from the portal application server while avoiding requesting the information retained on the client side.

In some embodiments according to the invention, the step of providing the requested information from the portal application server can include accessing customization information associated with a user profile of the client application on the server side. At least one portlet associated with the requested information can be accessed on the sever side. The requested information is provided based on the access to the at least one portlet and the customization information on the server side.

In some embodiments according to the invention, the requested information can include an HTML page provided by the portal application server including a portal page assembler, a portal page configuration based the customization information and portlet data including new data for display by the client application. The step of providing the requested information based on the access to the at least one portlet and the customization information on the server side can include providing the HTML page to the client side and invoking the portal page assembler to assemble a web page to be displayed by the client application including a view of the at least one portlet including the new data based on the portal page configuration.

### BRIEF DESCRIPTION OF THE FIGURES

FIG. 1 is an illustration of an exemplary portal that can be provided utilizing embodiments according to the invention.

FIG. 2 is a block diagram illustrating embodiments according to the invention.

FIG. 3 is a flowchart illustrating method embodiments according to the invention.

### DESCRIPTION OF EMBODIMENTS ACCORDING TO THE INVENTION

The present invention is described herein with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers and reference designators refer to like elements throughout.

As will be appreciated by one of skill in the art, the present invention may be embodied as methods, systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, or magnetic storage devices.

Computer program code or “code” for carrying out operations according to the present invention may be written in an object oriented programming language such as JAVA®, Smalltalk or C++, JavaScript, Visual Basic, TSQL, Perl , or in various other programming languages. Software embodiments of the present invention do not depend on implementation with a particular programming language. Portions of the code may execute entirely on one or more systems utilized by an intermediary server.

The code may execute entirely on one or more servers, or it may execute partly on a server and partly on a client within a client device or as a proxy server at an intermediate point in a communications network. In the latter scenario, the client device may be connected to a server over a LAN or a WAN (e.g., an intranet), or the connection may be made through the Internet (e.g., via an Internet Service Provider). It is understood that the present invention is not TCP/IP-specific or Internet-specific. The present invention may be embodied using various protocols over various types of computer networks.

The present invention is described below with reference to block diagrams and/or flowchart illustrations of methods, systems and computer program products according to embodiments of the invention. It is understood that each block of the block diagrams and/or flowchart illustrations, and combinations of blocks in the block diagrams and a flowchart illustration, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagrams and/or flowchart block or blocks.

These computer program instructions may be stored in a computer-readable memory that can direct a computer or other programmable data processing apparatus to function in a particular manner, such that the instructions stored in the computer-readable memory produce an article of manufacture including instruction means which implement the function specified in the block diagrams and/or flowchart block or blocks.

The computer program instructions may be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagrams and/or flowchart block or blocks.

As used herein, the term “Web site” can include a related collection of files that includes a beginning file called a home page. From the home page, a visitor can access other files and applications at the Web site. A large Web site may utilize a number of servers, which may or may not be different and may or may not be geographically-dispersed. For example, the Web site of the International Business Machines Corporation (www.ibm.com) consists of thousands of Web pages and files dispersed over multiple Web servers in locations world-wide.

Embodiments according to the invention can operate in a logically separated client side/server side computing environment, sometimes referred to hereinafter as a client/server environment. The client/server environment is a computational architecture that involves a client process (i.e., a client) requesting service from a server process (i.e., a server). In general, the client/server environment maintains a distinction between processes, although client and server processes may operate on different machines or on the same machine. Accordingly, the client and server sides of the client/server environment are referred to as being logically separated. Usually, when client and server processes operate on separate devices, each device can be customized for the needs of the respective process. For example, a server process can “run on” a system having large amounts of memory and disk space, whereas the client process often “runs on” a system having a graphic user interface provided by high-end video cards and large-screen displays.

A client can be a program, such as a web browser, that requests information, such as web pages, from a server. Examples of clients include browsers such as Netscape Navigator® (America Online, Inc., Dulles, Va.) and Internet Explorer® (Microsoft Corporation, Redmond, Wash.). Browsers typically provide a graphical user interface for retrieving and viewing web pages, web portals, applications, and other resources served by Web servers.

A server can be a program that responds to the requests from the client. Some examples of servers are International Business Machines Corporation's family of Lotus Domino® servers, the Apache server (available from http://www.apache.org), and Microsoft's Internet Information Server (IIS) (Microsoft Corporation, Redmond, Wash.).

The clients and servers can communicate using a standard communications mode, such as Hypertext Transport Protocol (HTTP). According to the HTTP request-response communications model, HTTP requests are sent from the client to the server and HTTP responses are sent from the server to the client in response to an HTTP request. In operation, the server waits for a client to open a connection and to request information, such as a Web page. In response, the server sends a copy of the requested information to the client, closes the connection to the client, and waits for the next connection. It will be understood that the server can respond to requests from more than one client.

Although the present invention is described herein with reference to web pages, web servers, etc., it will be understood that the present invention can be practiced with any computer displayable documents having information. Furthermore, the present invention is not limited to the web. The term “network” includes the distribution of information among systems that communicate with each other over a communication link, such as over the Internet, an intranet, a wireless network, or any other type of communications system.

As is known to those skilled in this art, a Web page is conventionally formatted via a standard page description language such as HyperText Markup Language (HTML), which typically contains text and can reference graphics, sound, animation, and video data. HTML provides for basic document formatting and allows a Web content provider to specify anchors or hypertext links (typically manifested as highlighted text) to other servers. When a user selects (i.e., activates) a particular hypertext link, a browser running on the user's client device reads and interprets an address, called a Uniform Resource Locator (URL) associated with the hypertext link, connects the browser with a Web server at that address, and makes a request (e.g., an HTTP request) for the file identified in the hypertext link. The Web server then sends the requested file to the client which interprets and renders the Web page for display.

A web browser can be used to view what is sometimes referred to as a web portal (or portal). As understood by those skilled in the art, the web portals can operate according to the same communications protocols described above in reference to clients and servers where the client is a web browser that views portal pages and the server is sometimes referred to as an portal applications server that serves requested information to the web browser.

A portal can be a single presentation (or view) of information from multiple sources, sometimes referred to as an aggregation of information. Portals often include information such as: calendars and to-do lists, discussion groups, announcements and reports, news, stock quotes, searches, e-mail and address books, weather, maps, shopping, and the like, all of which may be provided to the portal by different sources and/or applications.

Much of the information provided by the portal can be customized by the user. For example, some portals, such as, My Lycos®, can be customized to display the weather forecast in a user's area or display sports scores for the user's favorite teams. Moreover, the customization can include the look and feel of portal itself. For example, some portals can be customized to be displayed using particular skins or screen themes.

A portal may also use profiling to present and customize content that interests the user and/or to provide accurate demographic data for prospective advertisers and to help them match ad content with likely sales prospects. Accordingly, portals, and recently other web providers such as news services, frequently request that the user fill out a profile form. The profile form may request, for example, the user's name, gender, age, address, income bracket, employment, recreational activities, hobbies, and the like. The data provided in the user profile may be used along with data mining, i.e. technique for selecting contact information for a small segment of the population from a large database of contact information, to learn more about the user and target the user for, for example, print, email and/or direct-mail advertising.

Portlets are visible active components users of the portal see within the portal page. Similar to a window in a PC desktop, each portlet is allocated a portion of the client screen where the relevant information is displayed. A portlet can be generated by a computer program, written for example in Java™, to provide the content to be embedded into portal pages viewed by the user. From a user's perspective, a portlet is a content channel or application to which the user can subscribe. The user can customize the portal page, to show information which is of interest to the user. From a content provider's view, a portlet is a means to make their content available to a user of the portal. From a portal administrator's view, a portlet is a content container that can be registered with the portal, so that users may subscribe to portal. From the portal's point of view, a portlet is a component rendered to the portal page.

Embodiments according to the present invention can aggregate information for display by a client application, Such as a web browser. In particular, in a logically separated client side/server side computing environment, information that is retained on the client side for display by the web browser can be aggregated with information that is requested by the web browser from a portal application server located on the server side of the environment. Accordingly, the aggregation of the information to be displayed can be provided on the client side rather than on the server side, thereby reducing the load on the portal application server and reducing the required bandwidth allocated to the web browser. In some embodiments according to the present invention, the web browser can be used to access a portal which supports multiple portlets, each of which can be customized by a user to display desired information. In some embodiments according to the invention, the web browser only requests the information that is needed for an updated display of the portal associated with the requested information and can avoid requesting information that is not needed for the updated display. By avoiding requesting information that is not needed, the load on the portal application server can be further reduced.

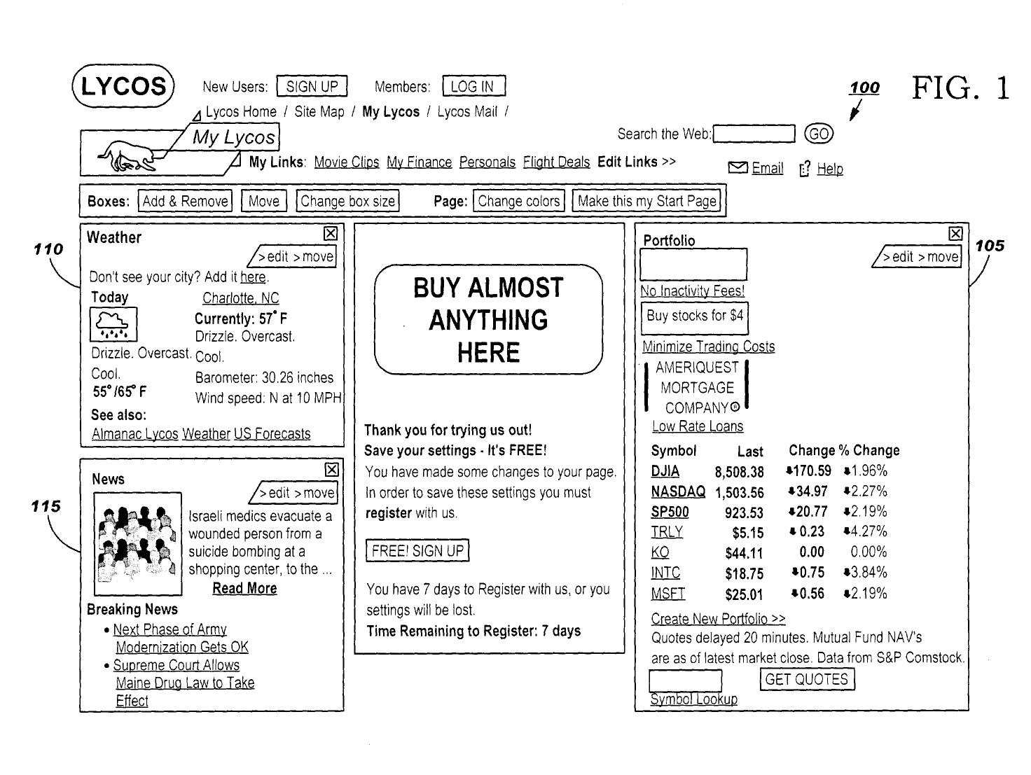

FIG. 1 is a schematic illustration of an exemplary portal 100 displayed by a web browser that can operate according to embodiments of the present invention. As shown in FIG. 1, the portal 100 includes multiple views of different information referred to as “portlets.” In particular, the portal 100 includes three portlets 105, 110, 115, which are related to the display of information related to stocks, weather, and news respectively. According to FIG. 1, the portlet 105 shows stock information that is of interest to the user, which can be customized to display information, such as prices, of stocks, bonds, stock exchanges, and the like. Portlet 110 displays weather information related to a particular geographic location of interest to the user and can also be customized. Portlet 115 shows news information of interest to the user, which can also be customized. In operation, a user can create a need for updated information for any of the portlets in the portal 100. For example, a user can request an updated stock quote via portlet 105, request updated weather through portlet 110, and/or request information related to a particular item in the latest news in portlet 115. In any event, the request for updated information can create a need to change some of the information displayed within at least one of the portlets 105, 110, and 115.

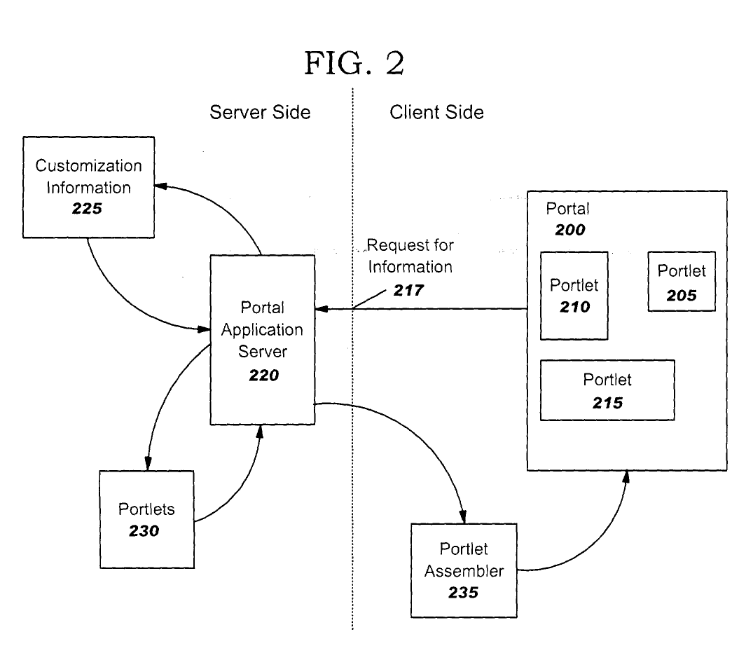

FIG. 2 is a block diagram illustrating embodiments according to the invention. According to FIG. 2, a portal 200 on a client side operates with a portal application server 220 on a server side in a logically separated client side/server side computing environment. The portal 200 can be provided by a client, such as a web browser, and includes portlets 205, 210, and 215 that can be displayed on the portal 200. When a user of the portal 200 requests updated information to be displayed in one of the portlets 205, 210, and 215, a request for information 217 is transmitted from the client (on the client side) to the portal application server 220 (located on the server side).

In some embodiments according to the invention, the request for information 217 can be associated with a particular portlet on the portal 200. In some embodiments according to the invention, the request for information 217 can be a request only for the information that is required to provide an updated display. For example, if the user of portal 200 requests new information for portlet 205, the request for information 217 can be a request for an updated display of the information shown in portlet 205 rather than a request for all of the information shown on the portal 200. In particular, the request for information 217 may not include a request for an updated display of the information shown in portlets 210 or 215 and, thereby avoid requesting information from the portal application server 220 that is retained on the client side for combination and display with the requested information provided by the portal application server 220.

The portlet application server 220 responds to the request for information 217 by accessing customization information 225 that can be associated with the user of the portal 200. The customization information 225 can also include information for customizing the particular portlet for which updated information is requested. For example, customization information 225 for a particular portlet can include a type of “skin” or screen information associated with how the portlet is to appear on the portal 200. Furthermore, the customization information 225 can include information associated with the type of information typically desired by the user, such as a particular location associated with weather information that is displayed in one of the portlets, a particular stock fund shown in one of the portlets on portal 200, or a particular sports teams of interest to the user.

The portal application server 220 also accesses a computer program (or portlet code) 230 associated with the portlet or portlets for which the request for information was made. The portlet code 230 provides the requested information to be returned to the client side for display in the respective portlet on the portal 200. For example, if the request for information 217 is associated with portlet 205 (e.g., a request for updated stock information), the portal application server 220 accesses portlet code 230 associated with portlet 205 that can be used to create the portlet 205 on the client side. The portal application server 220 provides the associated portlet code 230, and any customization information 225, and code for a portlet assembler 235 to the client side of the logically separated client side/server side computing environment. In some embodiments according to the invention, the information provided by the portal application server 220 (including the portlet assembler 235, portlet code 230 and customization information 225) is provided to the client side in the form of an HTML page that can be executed by the web browser that displays the portal 200.

The portlet assembler 235 is invoked on the client side and uses the portal code 230 to aggregate the information that was requested from the portal application server 220 (included in the portlet code 230) with information that was retained on the client side for display in the respective portlet of portal 200. For example, if the request for information 217 made to the portal application server 220 was associated only with portlet 210, the customization information 225 associated with portlet 210 and the portlet code 230 associated with portlet 210 is provided, along with the portlet assembler code 235 to the client side. In some embodiments according to the invention, the request for information 217 does not include a request for updated information associated with portlets 205 and 215. In other words, in some embodiments according to the invention, the information displayed in portlets 205 and 215 is retained on the client side. In some embodiments according to the invention, the information retained on the client side can include, for example, information related to whether another portlet is to be minimized or maximized as part of the aggregated display with requested information.

The portlet assembler code 235 aggregates the requested information associated with portlet 210 (provided in the portlet code 230 from the portal application server 220) with the information retained on the client side associated with portlets 205 and 215 to provide an updated display on the portal 200. Therefore, in embodiments according to the present invention, the portal application server 220 is requested to provide the information that is combined with the information retained on the client side to provide an updated display on portal 200.

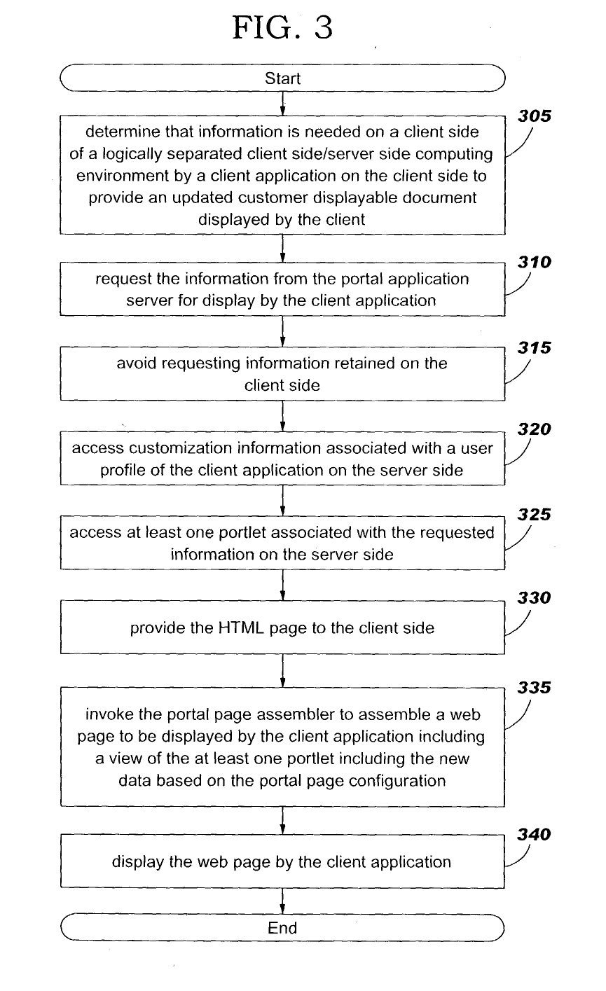

FIG. 3 is a flowchart illustrating method embodiments according to the present invention. As shown in FIG. 3, operations can begin by determining that information is needed on the client side of the logically separated client side/server side computing environment. The determination can be made by the client application (such as the web browser) located on the client side. The requested information can be used to provide an updated computer displayable document (such as a web page that includes multiple portlets displayed by a portal) (Block 305). A request for information is made to the portal application server for information to be displayed by the client (Block 310). However, the client avoids requesting information that is determined not to be needed for an updated display on the portal (i.e., the request for information does not include a request for information associated with portlets for which new information is not required) (Block 315).

The portlet application server accesses customization information associated with, for example, a user profile of the portal on the server side (Block 320). At least one portlet associated with the requested information is accessed on the server side by the portal application server (Block 325). The portal application server provides the portlet code associated with the requested information, the customization information, and portlet assembler code that can be used on the client side to aggregate the requested information provided by the portal application server (Block 330). The portal page assembler code is invoked on the client side to assemble the web page that includes the portlets to be displayed on the portal including the updated information included in the portlet provide by the portal application server (Block 335). The aggregated web page can then be displayed by the client application so that the user may view the portal showing the updated information (Block 340.)

Accordingly, in embodiments according to the invention, the loading of portal application servers can be reduced by aggregating portlets on the client side rather than on the server side of the logically separated client side/server side computing environment. Furthermore, in some embodiments according to the invention as discussed above, a request for information can be associated with the information needed for the updated display in a particular portlet and can avoid requesting information which is not needed for an updated display and will be retained on the client side.

In further embodiments according to the invention, the HTML page provided by the portal application server uses references defined by the W3C Document Object Model (DOM) standard to update information included in a portlet on the portal. DOM is a platform and language neutral interface that permits a script to access and update the content, structure, and style of a document.

The W3C DOM defines a model for how a standard set of objects representing HTML and Extensible Markup Language (XML) documents are combined, and an interface for accessing and manipulating them. Using a DOM-supporting programming language, such as Javascript, information within the portlet can be manipulated. For example, a DOM reference can be used to directly insert the requested information into the HTML page to be displayed by the client. Another aspect of W3C DOM is the ability to access any component of a document, to update the content (information) included in the document, and the ability to manipulate the information separately. For example, W3C DOM can be used to move an object from one part of a document to another.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

1. A method of providing information to a client application, comprising:
aggregating, on a client side of a logically separated client side/server side computing environment, information retained on the client side that is displayed by a client application with requested information provided by a portal application server on the server side of the client side/server side environment for display by the client application.

2. A method according to claim 1 wherein the step of aggregating comprises the step of:
combining information retained on the client side for display by the client application with the requested information to provide a computer displayable document for display by the client application.

3. A method according to claim 1 wherein the step of aggregating comprises:
requesting the information from the portal application server on the server side by the client application on the client side;
providing the requested information from the portal application server to the client application responsive to the requesting information by the client application; and
aggregating the requested information with information retained on the client side for display by the client application.

4. A method according to claim 3 further comprising:
avoiding requesting the information retained on the client side from the portal application server.

5. A method according to claim 3 wherein the step of requesting information further comprises:
determining that the information is needed for display by the client application of an updated computer displayable document; and
requesting the information from the portal application server;
avoiding requesting the information retained on the client side.

6. A method according to claim 5 wherein the step of avoiding comprises requesting only the information needed for display of the updated computer displayable document.

7. A method according to claim 3 wherein the step of providing the requested information from the portal application server comprises:
accessing customization information associated with a user profile of the client application on the server side;
accessing at least one portlet associated with the requested information on the sever side; and
providing the requested information based on the access to the at least one portlet and the customization information on the server side.

8. A method according to claim 7 wherein the requested information comprises an HTML page provided by the portal application server including a portal page assembler, a portal page configuration based the customization information and portlet data including new data for display by the client application:
the step of providing the requested information based on the access to the at least one portlet and the customization information on the server side comprises:
providing the HTML page to the client side;
invoking the portal page assembler to assemble a web page to be displayed by the client application including a view of the at least one portlet including the new data based on the portal page configuration; and
displaying the web page by the client application.

9. A method according to claim 8 wherein the step of invoking the portal page assembler to assemble a web page comprises assembling the web page by a reference using a document object model.

10. A method of providing information from a portal application server to a client application, comprising:
determining that information is needed on a client side of a logically separated client side/server side computing environment by a client application on the client side to provide an updated computer displayable document displayed by the client;
requesting the information from the portal application server for display by the client application;
avoiding requesting information retained on the client side;
providing the requested information from the portal application server to the client application responsive to the requesting information by the client application; and
aggregating the requested information with the information retained on the client side for display by the client application.

11. A method according to claim 10 wherein the step of providing the requested new information from the portal application server comprises:
accessing customization information associated with a user profile of the client application on the server side;
accessing at least one portlet associated with the requested information on the sever side; and
providing the requested information based on the access to the at least one portlet and the customization information on the server side.

12. A method according to claim 11 wherein the requested information comprises an HTML page provided by the portal application server including a portal page assembler, a portal page configuration based the customization information and portlet data including new data for display by the client application:
wherein the step of providing the requested information based on the access to the at least one portlet and the customization information on the server side comprises:
providing the HTML page to the client side;
invoking the portal page assembler to assemble a web page to be displayed by the client application including a view of the at least one portlet including the new data based on the portal page configuration; and
displaying the web page by the client application.

13. A system for providing information to a client application, comprising:
means for aggregating, on a client side of a logically separated client side/server side computing environment, information retained on the client side that is displayed by a client application with requested information provided by a portal application server on the server side of the client side/server side environment for display by the client application.

14. A system according to claim 13 wherein the means for aggregating comprises:
means for combining information retained on the client side for display by the client application with the requested information to provide a computer displayable document for display by the client application.

15. A system according to claim 13 wherein the means for aggregating comprises:
means for requesting the information from the portal application server on the server side by the client application on the client side;
means for providing the requested information from the portal application server to the client application responsive to the requesting information by the client application; and
means for aggregating the requested information with information retained on the client side for display by the client application.

16. A system according to claim 15 further comprising:
means for avoiding requesting the information retained on the client side from the portal application server.

17. A system according to claim 15 wherein the means for requesting information further comprises:
means for determining that the information is needed for display by the client application of an updated computer displayable document; and
means for requesting the information from the portal application server;
means for avoiding requesting the information retained on the client side.

18. A system according to claim 17 wherein the means for avoiding comprises means for requesting only the information needed for display of the updated computer displayable document.

19. A system according to claim 15 wherein the means for providing the requested information from the portal application server comprises:
means for accessing customization information associated with a user profile of the client application on the server side;
means for accessing at least one portlet associated with the requested information on the sever side; and
means for providing the requested information based on the access to the at least one portlet and the customization information on the server side.

20. A system according to claim 19 wherein the requested information comprises an HTML page provided by the portal application server including a portal page assembler, a portal page configuration based the customization information and portlet data including new data for display by the client application:
the means for providing the requested information based on the access to the at least one portlet and the customization information on the server side comprises:
means for providing the HTML page to the client side;
means for invoking the portal page assembler to assemble a web page to be displayed by the client application including a view of the at least one portlet including the new data based on the portal page configuration; and
means for displaying the web page by the client application.

21. A system according to claim 20 wherein the means for invoking the portal page assembler to assemble a web page comprises means for assembling the web page by a reference using a document object model.

22. A system for providing information from a portal application server to a client application, comprising:
means for determining that information is needed on a client side of a logically separated client side/server side computing environment by a client application on the client side to provide an updated computer displayable document displayed by the client;
means for requesting the information from the portal application server for display by the client application;
means for avoiding requesting information retained on the client side;
means for providing the requested information from the portal application server to the client application responsive to the requesting information by the client application; and
means for aggregating the requested information with the information retained on the client side for display by the client application.

23. A system according to claim 22 wherein the means for providing the requested new information from the portal application server comprises:
means for accessing customization information associated with a user profile of the client application on the server side;
means for accessing at least one portlet associated with the requested information on the sever side; and
means for providing the requested information based on the access to the at least one portlet and the customization information on the server side.

24. A system according to claim 22 wherein the requested information comprises an HTML page provided by the portal application server including a portal page assembler, a portal page configuration based the customization information and portlet data including new data for display by the client application:
wherein the means for providing the requested information based on the access to the at least one portlet and the customization information on the server side comprises:
means for providing the HTML page to the client side;
means for invoking the portal page assembler to assemble a web page to be displayed by the client application including a view of the at least one portlet including the new data based on the portal page configuration; and
means for displaying the web page by the client application.

25. A computer program product for providing information to a client application, comprising:
a computer readable medium having computer readable program code embodied therein, the computer readable program product comprising:
computer readable program code configured to aggregate, on a client side of a logically separated client side/server side computing environment, information retained on the client side that is displayed by a client application with requested information provided by a portal application server on the server side of the client side/server side environment for display by the client application.

26. A computer program product according to claim 25 wherein the computer readable program code configured to aggregate comprises:
computer readable program code configured to combine information retained on the client side for display by the client application with the requested information to provide a computer displayable document for display by the client application.

27. A computer program product according to claim 25 wherein the computer readable program code configured to aggregate comprises:
computer readable program code configured to request the information from the portal application server on the server side by the client application on the client side;
computer readable program code configured to provide the requested information from the portal application server to the client application responsive to the computer readable program code configured to request information by the client application; and
computer readable program code configured to aggregate the requested information with information retained on the client side for display by the client application.

28. A computer program product according to claim 27 further comprising:
computer readable program code configured to avoid requesting the information retained on the client side from the portal application server.

29. A computer program product according to claim 27 wherein the computer readable program code configured to request information further comprises:
computer readable program code configured to determine that the information is needed for display by the client application of an updated computer displayable document; and
computer readable program code configured to request the information from the portal application server;
computer readable program code configured to avoid requesting the information retained on the client side.

30. A computer program product according to claim 29 wherein the computer readable program code configured to avoid comprises computer readable program code configured to request only the information needed for display of the updated computer displayable document.

31. A computer program product according to claim 27 wherein the computer readable program code configured to provide the requested information from the portal application server comprises:
computer readable program code configured to access customization information associated with a user profile of the client application on the server side;
computer readable program code configured to access at least one portlet associated with the requested information on the sever side; and
computer readable program code configured to provide the requested information based on the access to the at least one portlet and the customization information on the server side.

32. A computer program product according to claim 31 wherein the requested information comprises an HTML page provided by the portal application server including a portal page assembler, a portal page configuration based the customization information and portlet data including new data for display by the client application:
the computer readable program code configured to provide the requested information based on the access to the at least one portlet and the customization information on the server side comprises:
computer readable program code configured to provide the HTML page to the client side;
computer readable program code configured to invoke the portal page assembler to assemble a web page to be displayed by the client application including a view of the at least one portlet including the new data based on the portal page configuration; and
computer readable program code configured to display the web page by the client application.

33. A computer program product according to claim 32 wherein the computer readable program code configured to invoke the portal page assembler to assemble a web page comprises means for assembling the web page by a reference using a document object model.

34. A computer program product for providing information from a portal application server to a client application, comprising:
a computer readable medium having computer readable program code embodied therein, the computer readable program product comprising:
computer readable program code configured to determine that information is needed on a client side of a logically separated client side/server side computing environment by a client application on the client side to provide an updated computer displayable document displayed by the client;
computer readable program code configured to request the information from the portal application server for display by the client application;
computer readable program code configured to avoid requesting information retained on the client side;
computer readable program code configured to provide the requested information from the portal application server to the client application responsive to the requesting information by the client application; and
computer readable program code configured to aggregate the requested information with the information retained on the client side for display by the client application.

35. A computer program product according to claim 34 wherein the computer readable program code configured to provide the requested new information from the portal application server comprises:
computer readable program code configured to accessing customization information associated with a user profile of the client application on the server side;
computer readable program code configured to access at least one portlet associated with the requested information on the sever side; and
computer readable program code configured to provide the requested information based on the access to the at least one portlet and the customization information on the server side.

36. A computer program product according to claim 35 wherein the requested information comprises an HTML page provided by the portal application server including a portal page assembler, a portal page configuration based the customization information and portlet data including new data for display by the client application:
wherein the computer readable program code configured to provide the requested infonnation based on the access to the at least one portlet and the customization information on the server side comprises:
computer readable program code configured to provide the HTML page to the client side;
computer readable program code configured to invoke the portal page assembler to assemble a web page to be displayed by the client application including a view of the at least one portlet including the new data based on the portal page configuration; and
computer readable program code configured to display the web page by the client application.
